(19) United States
(12) Patent Application Publication
(10) Pub. No.: US 2007/0180292 A1
(43) Pub. Date: Aug. 2, 2007

(54) Differential rebuild in a storage environment

(76) Inventor: Kern S. Bhugra, Fremont, CA (US)

Correspondence Address: RAJ ABHYANKER, LLP;c/o PORTFOLIOIP, P.O. BOX 52050, MINNEAPOLIS, MN, 55402, US

(21) Appl. No.: 11/343,814

(22) Filed: Jan. 31, 2006

(51) Int. Cl. G06F 11/00

(52) U.S. Cl. 714/6

(57) ABSTRACT

Differential rebuild in a storage environment is disclosed. In one embodiment, a method includes applying a fault-tolerant algorithm (e.g., a redundant array of independent disk (RAID) level 1, level 3, level 4, level 5, level 6, level 10, level 30, level 50, and/or level 60 algorithm) to process commands associated with at least one storage device of a disk array that is disengaged, and applying write data captured while the at least one storage device was disengaged to the at least one storage device when it is reengaged. The method may include rebuilding the data state before (e.g., and/or when) the storage device was disengaged on a replacement device (e.g., a full rebuild) or may include a differential rebuild (e.g. the applying write data captured while the at least one storage device was disengaged may be performed on the at least one storage device when it is reengaged).

### FIELD OF TECHNOLOGY

This disclosure relates generally to the technical fields of storage environments, in one example embodiment, to a method and a system of differential rebuild in a storage environment.

### BACKGROUND

In computing, a redundant array of independent disks (more commonly known as a RAID) is a system of multiple storage devices (e.g., hard drives) to spread across and/or to reconstruct data among the drives. Thus, instead of seeing several different storage devices, an operating system may see only one virtual device (e.g., instead of individual drives). At the very simplest level, the RAID is one of many ways to combine multiple storage devices into one single logical unit. The RAID can be implemented in hardware and/or software. Depending on a version chosen (e.g., a RAID level), a benefit of the RAID may be increased data integrity and/or fault-tolerance, compared to a single storage device.

A fault-tolerant algorithm is used in some of the RAID levels (e.g., level 1, level 3, level 4, level 5, level 6, level 10, level 30, level 50, and/or level 60 algorithm) to enhance reliability and/or availability. Therefore, if a storage device in the RAID fails (e.g., a failed storage device), the fault-tolerant algorithm can reconstruct data stored on the failed storage device using the fault-tolerant algorithm (e.g., a bit from a storage device 1 is XOR'd with a bit from a storage device 2, and the result bit is stored on a storage device 3).

A storage enclosure may contain the multiple storage devices forming the RAID. When one or more of the multiple storage devices in the storage enclosure is disengaged (e.g., because of a hardware failure, loss of power, bad sector, etc.), an administrator (e.g., a network administrator) may replace the disengaged storage device(s) and all of the data in the disengaged storage device(s) may be reconstructed using the fault-tolerant algorithm. In addition, if the administrator accidentally disengages a functioning storage device in the storage enclosure, all the data on the disengaged storage device may be reconstructed on a spare device and/or when another functioning storage device is reengaged. When there is a large amount of data in the disengaged storage device(s), reconstructing all of the data can be an expensive, slow, and inefficient process.

### SUMMARY

Differential rebuild in a storage environment is disclosed. In one aspect, a method includes applying a fault-tolerant algorithm (e.g., a redundant array of independent disk (RAID) level 1, level 3, level 4, level 5, level 6, level 10, level 30, level 50, and/or level 60 algorithm) to process commands associated with at least one storage device of a disk array that is disengaged, and applying write data associated with the at least one storage device captured while it was disengaged to the at least one storage device when it is reengaged. The method may include rebuilding the data state of the at least one storage device while it is disengaged on a replacement device (e.g., the applying write data captured while the at least one storage device was disengaged may be performed on the replacement device).

It should be noted that the replacement device may a spare device in the disk array and the write data may be stored on the spare device (e.g., a second spare device) of the disk array. The spare device (e.g., the second spare device) may be used to process commands associated with the at least one storage device of the disk array that is disengaged. In addition, the method may determine that the at least one storage device of the disk array is disengaged when a parameter exceeds a threshold value. The method may reattempt a response request until a command parameter of the at least one storage device exceeds a particular value.

In another aspect, a method includes providing a canister having at least one unresponsive storage device (e.g., the at least one unresponsive storage device may be part of a RAID (e.g., a storage volume) comprising of multiple storage devices across different canisters) and at least one functioning storage device that is disengaged; and differentially rebuilding data on the at least one functioning storage device (e.g., when it is reengaged) using a write command captured when the least one functioning storage device was disengaged. The method may process commands (e.g., read and/or write commands) associated with data of the canister based on the fault-tolerant algorithm when the canister is disengaged. In addition, the method may automatically capture the write command associated with data stored in the canister based on the fault-tolerant algorithm. The method may also detect that the canister has been reengaged and may include at least one replacement storage device. Data of the at least one unresponsive storage device may be fully rebuilt on the at least one replacement storage device using the fault-tolerant algorithm. The method may also apply write data captured when the canister was disengaged corresponding to the at least one unresponsive storage device on the at least one replacement device.

In addition, the method may include rebuilding a data state associated with the at least one functional storage device when the canister is disengaged on at least one replacement drive using a fault-tolerant algorithm. The method may also apply write data captured when the canister was disengaged corresponding to the at least one functional storage device on the at least one replacement device. The write data may be stored on a spare device of the disk array. The spare device may be used to process commands associated with the at least one unresponsive storage device when the canister is disengaged. The replacement device can also be the spare device. In addition, the method may also determine that the at least one storage device in the canister is unavailable when a parameter exceeds a threshold value and may also reattempt a response request until a command parameter of the at least one storage device exceeds a particular value.

In a further aspect, a method includes determining that a storage device is disengaged, processing commands (e.g., read and/or write commands) associated with data on the storage device based on a fault-tolerant algorithm, automatically capturing a write command associated with data of the storage device based on the fault-tolerant algorithm, and applying a differential rebuild on the storage device when it is reengaged.

Other features will be apparent from the accompanying drawings and from the detailed description that follows.

### BRIEF DESCRIPTION OF THE DRAWINGS

Example embodiments are illustrated by way of example and not limitation in the Figures of the accompanying drawings, in which like references indicate similar elements and in which:

FIG. 1 is a perspective view of a single-depth storage enclosure, according to one embodiment.

FIG. 2 is a perspective view of a multi-depth storage enclosure, according to one embodiment.

FIG. 3 is an exploded view of a canister in the multi-depth storage enclosure of FIG. 2 having multiple storage devices, according to one embodiment.

FIG. 4 is a diagrammatic representation of a machine having a rebuild module, in an example form of a computer system in which there are a set of instructions that cause the machine to perform any one or more of the methodologies discussed herein, according to one embodiment.

FIG. 5 is an exploded view of the rebuild module of FIG. 4, according to one embodiment.

FIG. 6 is a process flow to apply write data captured when at least one of the storage devices was disengaged, according to one embodiment.

FIG. 7 is a process flow to differentially rebuild data on a functioning storage device using a write command captured when the functioning storage device was disengaged, according to one embodiment.

FIG. 8 is a process flow to automatically capture a write command associated with data of a disengaged storage device and to apply a differential rebuild on the storage device when it is reengaged, according to on embodiment.

FIG. 9 is a three-dimensional view of an exemplary multi-depth storage enclosure in which one or more storage devices may be removed in multiple ways, according to one embodiment.

Other features of the present embodiments will be apparent from the accompanying drawings and from the detailed description that follows.

### DETAILED DESCRIPTION

A method and system to differentially rebuild data in a storage environment is described. In the following description, for purposes of explanation, numerous specific details are set forth in order to provide a thorough understanding of the various embodiments. It will be evident, however, to one skilled in the art that the various embodiments may be practiced without these specific details. An example embodiment provides methods and systems to differentially rebuild data on one or more functioning storage device(s) using one or more write command(s) captured when the one or more functioning storage device(s) was disengaged. Example embodiments of a method and a system, as described below, may be used to restore data in a disk array (e.g., a RAID) without reconstructing all of the data of one or more disengaged devices. It will be appreciated that the various embodiments discussed herein may/may not be the same embodiment, and may be grouped into various other embodiments not explicitly disclosed herein.

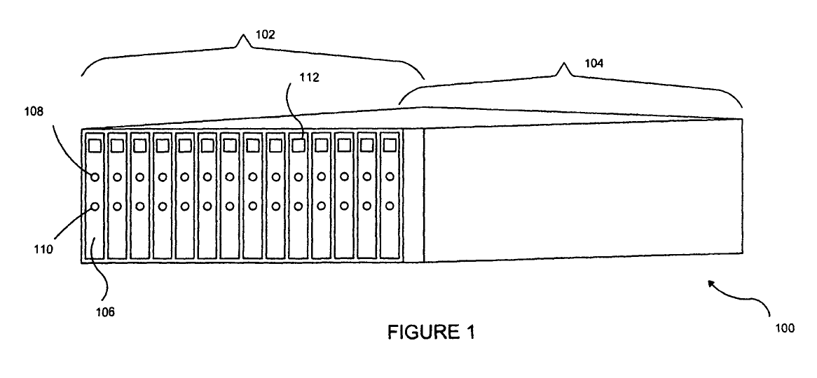

FIG. 1 is a perspective view of a single-depth storage enclosure 100, according to one embodiment. In FIG. 1, the single-depth storage enclosure 100 (e.g., hereinafter “enclosure 100”) is illustrated as having any number of single-disk carriers (e.g., a single-disk carrier 106), and as having a length 102 and a width 104. Each of the single-disk carriers may include one storage device (e.g., a hard drive). For example, the single-disk carrier 106 may include the hard drive. One or more hard drives inside (and/or outside) the enclosure 100 may be grouped together to form a single logical volume (e.g., may appear as one storage device to an operating system associated with the enclosure 100). The single drive carriers (e.g., the single-disk carrier 106) each may include a status indicator 108 and an activity indicator 110. The status indicator 108 may indicate that the storage device in the single-disk carrier 106 is receiving power (e.g., turned on). The activity indicator 110 may indicate that an operation (e.g., such as a read operation, a write operation, a seek operation, etc.) is being processed by the storage device in the single-disk carrier 106. If the storage device in the single-disk carrier 106 fails, the storage device in the single-disk carrier 106 may be removed when an eject button 112 is depressed.

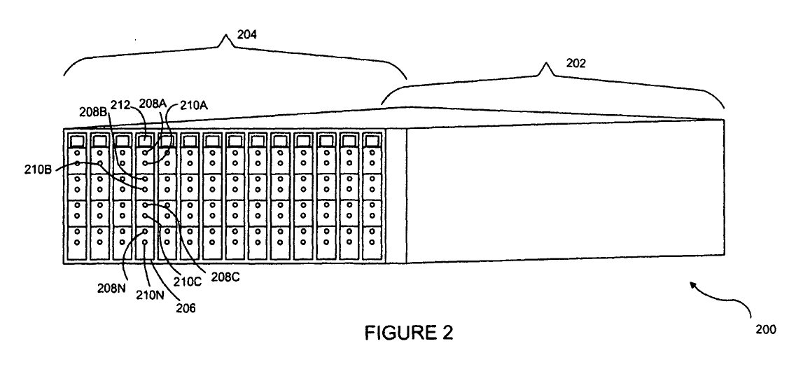

FIG. 2 is a perspective view of a multi-depth storage enclosure 200, according to one embodiment. In FIG. 2, the multi-depth storage enclosure 200 (e.g., hereinafter “enclosure 200”) is illustrated as having any number of canisters (e.g., a canister 206), and as having a length 202 and a width 204. The canister 206 may include any number of storage devices (e.g., any number of hard drives). In one embodiment, the storage devices in the canister 206 are any one or more of serial ATA (SATA) hard drives, parallel ATA (PATA) hard drives, or any other type of storage device. Since each canister (e.g., the canister 206) in the enclosure 200 stores multiple storage devices, costs of manufacturing and/or operating the enclosure 200 may be lower than the cost of operating the enclosure 100 of FIG. 1.

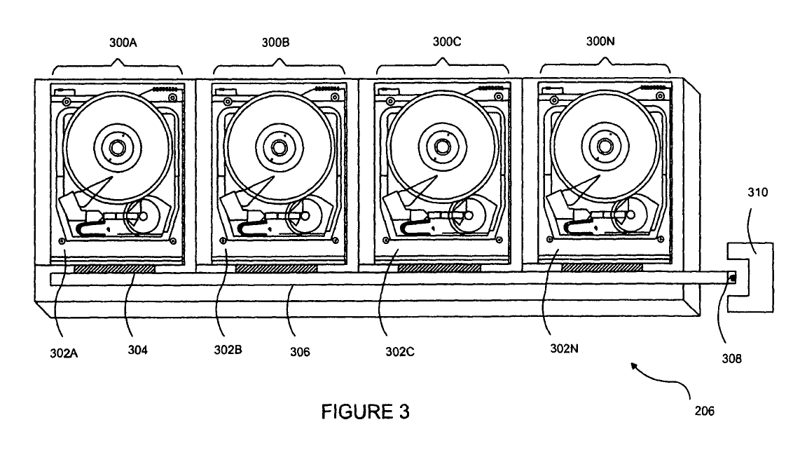

There are a number of status indicators 208 and activity indicators 210 in the enclosure 200 of FIG. 2 on each canister (e.g., the canister 206). To illustrate, consider the exploded view of the canister 206 of the enclosure 200 in FIG. 2 as illustrated in FIG. 3. In FIG. 3, the canister 206 is illustrated as having multiple storage devices 300, according to one embodiment. A status indicator 208A of FIG. 2 may correspond to a capsule 300A holding a storage device 302A in the canister 206 as illustrated in FIG. 3. A status indicator 208B of FIG. 2 may correspond to a capsule 300B holding a storage device 302B in the canister 206 as illustrated in FIG. 3. A status indicator 208C of FIG. 2 may correspond to a capsule 300C holding a storage device 302C in the canister 206 as illustrated in FIG. 3. A status indicator 208N of FIG. 2 may correspond to a capsule 300N holding a storage device 302N in the canister 206 as illustrated in FIG. 3 (e.g., where N may be any number, as there may be any number of devices within the canister 206).

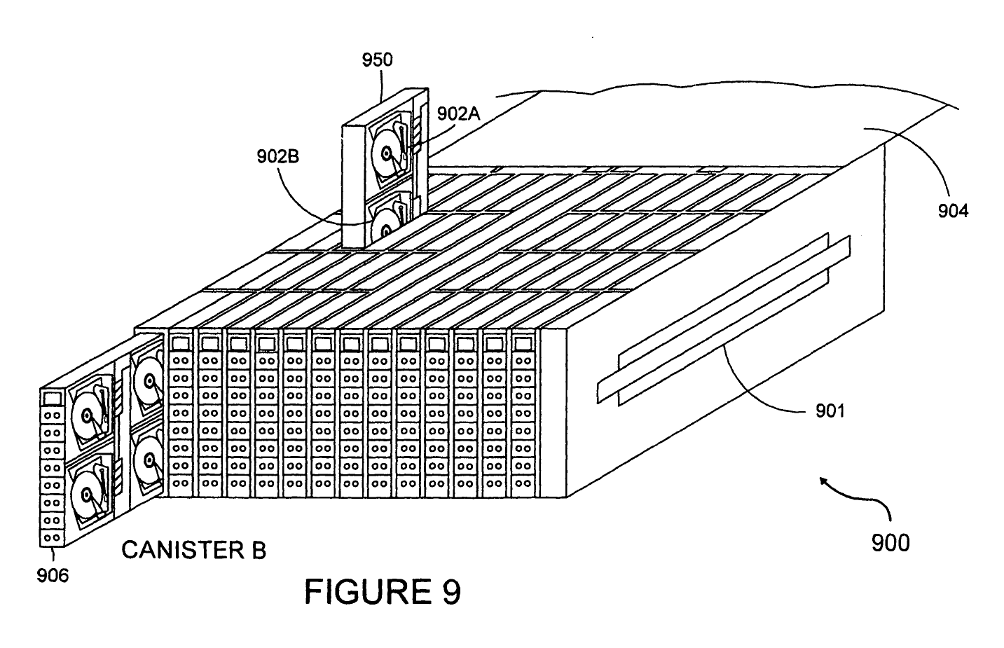

Each capsule 300 may be removed when the canister 206 is disengaged (e.g., when an eject button 212 is depressed on the canister 206). In one embodiment, the canister 206 is removed from the front of the enclosure 200 and the canister 206 is pulled out forward (e.g., manually pulled forward by an administrator) from the front of the enclosure 200 when the eject button 212 is depressed. In alternate embodiments, each capsule 300 may be individually removable from the top of the enclosure 200 (e.g., as illustrated in an exemplary multi-depth enclosure 900 in FIG. 9). Each storage device 302 may include a connector 304 that connects each storage device 302 to a perpendicular arm 306. The perpendicular arm 306 may connect to a backplane 310 (e.g., the backplane 310 may connect each canister in the enclosure 200 to each other).

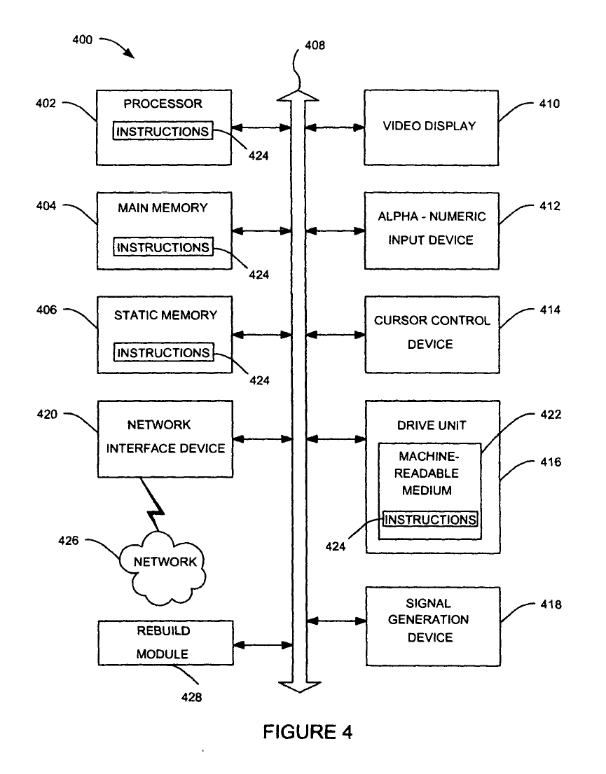

FIG. 4 is a diagrammatic representation of a machine 400 having a rebuild module 428, in an example form of a computer system in which there are a set of instructions that cause the machine to perform any one or more of the methodologies discussed herein, according to one embodiment. In various embodiments, the machine (e.g., a data processing system) operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a server, a web appliance, a network router, switch and/or bridge, an embedded system and/or any other data processing system and/or machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 400 includes a processor 402 (e.g., a central processing unit (CPU) a graphics processing unit (GPU) and/or both), a main memory 404 and a static memory 406, which communicate with each other via a bus 408. The computer system 400 may further include a video display unit 410 (e.g., a liquid crystal display (LCD) and/or a cathode ray tube (CRT)). The computer system 400 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies and/or functions described herein. The software 424 may also reside, completely and/or at least partially, within the main memory 404 and/or within the processor 402 during execution thereof by the computer system 400, the main memory 404 and the processor 402 also constituting machine-readable media.

The software 424 may further be transmitted and/or received over a network 426 via the network interface device 420. While the machine-readable medium 422 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

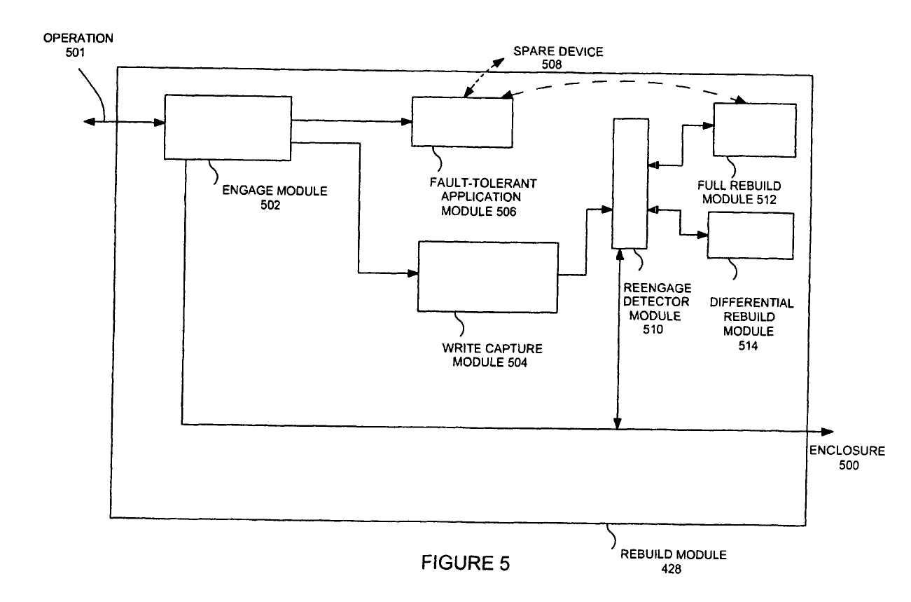

FIG. 5 is an exploded view of the rebuild module 428 of FIG. 4, according to one embodiment. In FIG. 5, an operation 501 (e.g., read, write, verify, seek, etc.) is received by an engage module 502 in the rebuild module 428 (e.g., received from an operating system/data processing system associated with an enclosure, such as the enclosure 200). The engage module 502 may determine whether a particular storage device (e.g., a particular hard drive, such as the storage device 302A in FIG. 3) is engaged (e.g., available, active, operational, accessible, functional, etc.) by consulting an enclosure 500 (e.g., the enclosure 500 may be any one or more of the enclosure 100 in FIG. 1, the enclosure 200 in FIG. 2, and/or the enclosure 900 in FIG. 9). In an alternate embodiment, the engage module 352 may determine whether a particular data block, data sector, or memory cell in any one or more of the storage devices in the enclosure 500 is engaged.

When a target (e.g., the particular storage device, data block, sector, and/or memory cell, etc.) in the enclosure 500 is engaged, the engage module 502 responds to the operation 501 by performing the operation 501 (e.g., read, write, seek) on the particular storage device associated with the target (e.g., the target may be the particular data block in the enclosure 500 that is requested by operation 501). However, when the engage module 502 detects that the target is disengaged (e.g., unavailable, inactive, not operational, not accessible, not functional, etc.), the engage module 502 alerts a fault-tolerant application module 506, and a write capture module 504.

The fault-tolerant application module 506 may apply a fault-tolerant algorithm (e.g., a redundant array of independent disk (RAID) level 1, level 3, level 4, level 5, level 6, level 10, level 30, level 50, and/or level 60 algorithm) to process the operation 501 even when the target is disengaged. For example, the fault-tolerant application module 506 may respond if the operation 501 is a read operation by applying the fault-tolerant algorithm (e.g., generating the read data from a RAID algorithm) and responding to the operation 501. In addition, the fault-tolerant application module 506 may use a spare device 508 in the enclosure 500 to reconstruct a disengaged target. If the operation 501 is a write command, the write capture module 504 may store the write command (e.g., in a storage device, such as the spare device 508, etc.) until the target is reengaged.

A determination may be made whether the target is reengaged by a reengage detector module 510. The reengage detector module 510 may consult the enclosure 500 to determine whether a device (e.g., the target) has been reengaged (e.g., available, active, operational, accessible, functional, etc.). For example, reengagement may occur when an administrator replaces a particular storage device 302A in a canister 206 as illustrated in FIG. 2 and FIG. 3. If the reengage detector module 510 determines that the target is reengaged, it then may determine whether a full-rebuild or a differential-rebuild is required (e.g., by using a unique identifier written on a device to determine if the same device is being reengaged).

In one embodiment, the reengage detector module 510 may compare a unique identifier in a newly engaged target (e.g., a replacement storage device) with meta-data that has been stored in the fault-tolerant module 506. If the data (e.g., a unique identifier) is the same in the newly engaged target and the meta-data stored and/or reconstructed by the fault-tolerant module 506 (e.g., the last meta-data state before the target was disengaged), then the reengage detector module applies a differential rebuild (e.g., by applying the write command captured by the write capture module 504 to the data on the reengaged target, rather than fully reconstructing/rebuilding all the data on the reengaged target). If the unique identifier on the newly engaged target is different than the meta-data stored and/or reconstructed by the fault-tolerant module 506, then the reengage module 510 may apply a full rebuild using a full rebuild module 512 (e.g., by formatting the newly engaged target, copying all of the data reconstructed by the fault-tolerant application module 506 on the reengaged target, and then optionally applying the write command captured by the write capture module 504 to the fully reconstructed data in the reengaged target).

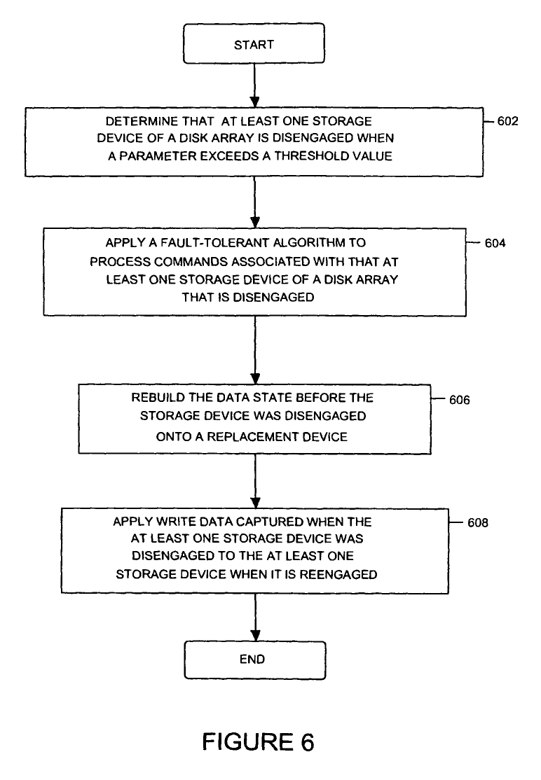

FIG. 6 is a process flow to apply write data captured (e.g., captured using the write capture module 504 of FIG. 5) when at least one of the storage devices (e.g., of FIG. 1, FIG. 2 and/or FIG. 9) was disengaged, according to one embodiment. In operation 602, a determination may be made that at least one storage device (e.g., the storage device 302A, 302B, 302N, etc.) is disengaged (e.g., unavailable, inactive, not operational, not accessible, not functional, etc.) when a parameter exceeds a threshold value (e.g., the parameter may be defined by an administrator and used by the engage module 502 of FIG. 5 to determine whether the target is engaged and/or disengaged). If the target (e.g., as described in FIG. 5) is disengaged, in operation 602, a fault-tolerant algorithm (e.g., a redundant array of independent disk (RAID) level 1, level 3, level 4, level 5, level 6, level 10, level 30, level 50, and/or level 60 algorithm) may be applied to process commands associated with at least one storage device of a disk array (e.g., the disk array may be the enclosure 200) that is disengaged.

Next, in operation 606, the data state of the at least one storage device that was disengaged may be fully rebuilt on a replacement drive (e.g., the spare device 508 of FIG. 5) using the fault-tolerant algorithm. In alternative embodiments, the replacement data may be rebuilt on one or more of the functional storage devices associated with a volume on which the disengaged target was located (e.g., using the fault-tolerant algorithm).

Then, in operation 608, write data may be applied that has been captured while the at least one storage device was disengaged (e.g., captured by the write capture module 504 of FIG. 4) to the at least one storage device when it is reengaged (e.g., when an administrator inadvertently depresses the eject button 112 on the single-disk carrier 106 of FIG. 1 and/or the eject button 212 on the canister 206 of FIG. 2, and reinserts the single disk carrier 106 and/or the canister 206).

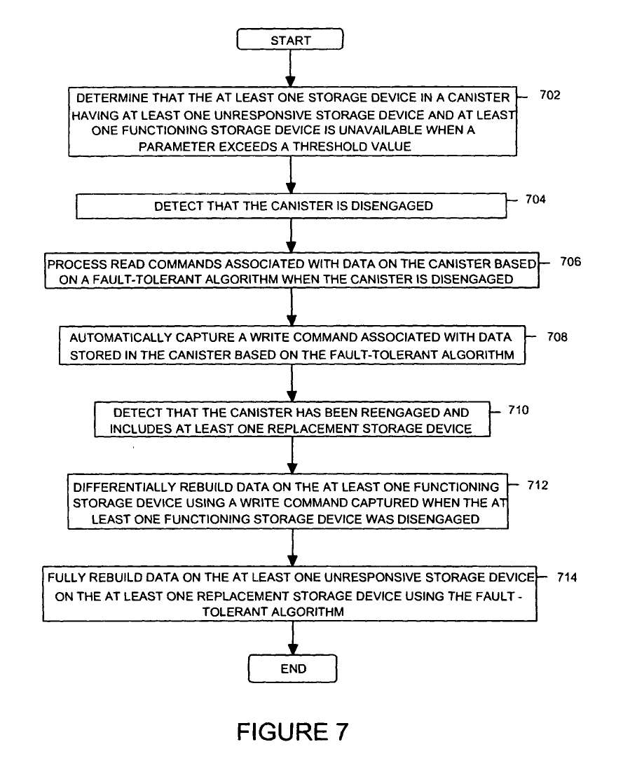

FIG. 7 is a process flow to differentially rebuild data (e.g., using the differential rebuild module 514 of FIG. 5) on a functioning storage device (e.g., of FIG. 2 and/or FIG. 9) using a write command captured when the functioning storage device was disengaged, according to one embodiment. In operation 702, a determination may be made that at least one storage device in a canister (e.g., the canister 206 of FIG. 2) having at least one unresponsive storage device and at least one functioning storage device is unavailable when a parameter (e.g., defined by an administrator) exceeds a threshold value.

In operation 704, it may be detected that the canister (e.g., the canister 206) is disengaged. In operation 706, commands (e.g., read and/or write commands) associated with data on the canister (e.g., the canister 206) may be processed based on a fault-tolerant algorithm (e.g., a RAID level having the ability to reconstruct data, as described in FIG. 5) when the canister is disengaged (e.g., using the fault-tolerant application module 506). In one embodiment, a data state associated with the at least one unresponsive storage device before (and/or when) the canister is disengaged may be rebuilt on at least one replacement drive using the fault-tolerant algorithm (e.g., using the fault-tolerant application module 506 as illustrated in FIG. 5).

Then, in operation 708, a write command (e.g., one or more write commands) associated with data stored in the canister (e.g., on one more of the storage devices 302 in the canister 206 as illustrated in FIG. 3) may be automatically captured (e.g., using the write capture module 504 of FIG. 5) based on the fault-tolerant algorithm. In addition, the write command may be placed into a journal (e.g., in addition to updating the redundancy groups). In one embodiment, reduced redundancy groups are updated so that read commands are efficient and don't need to search the captured write commands.

Next, in operation 710, a determination is made that storage devices within the disengaged canister have been reengaged (e.g., may be determined using the reengage detector module 510 of FIG. 5), In operation 712, data on the at least one functioning storage device may be differentially rebuilt (e.g., by applying the differential rebuild module 514 of FIG. 5) using a write command captured (e.g., captured by the write capture module 504) while the at least one functioning storage device was disengaged. Next, in operation 714, data on the at least one unresponsive storage device (e.g., a defective hard drive) may be fully rebuilt (e.g., using the full rebuild module 512 of FIG. 5) on the at least one replacement storage device using the fault-tolerant algorithm (e.g., a RAID level having the ability reconstruct data, as described in FIG. 5).

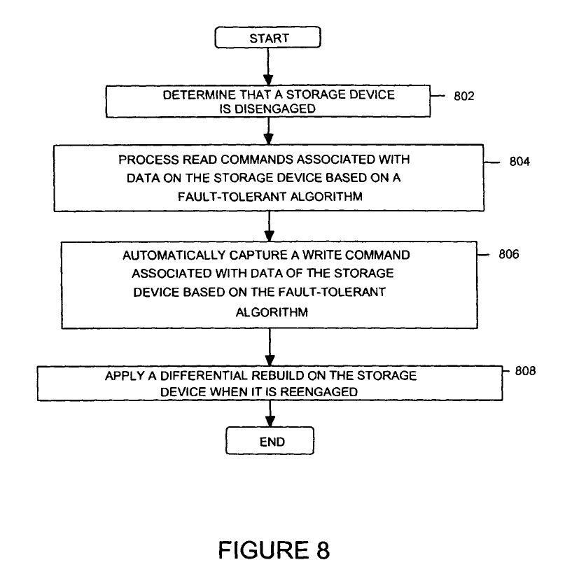

FIG. 8 is a process flow to automatically capture a write command (e.g., using the write capture module 504) associated with data of a disengaged storage device (e.g., of FIG. 1, FIG. 2 and/or FIG. 9) and to apply a differential rebuild (e.g., using the differential rebuild module 514 of FIG. 5) on the storage device when it is reengaged, according to one embodiment. In operation 802, a determination may be made that a storage device is disengaged (e.g., using the engage module 502, and observing whether a parameter exceeds a threshold value). In operation 804, commands (e.g., read and/or write commands) associated with data on the storage device may be processed based on a fault-tolerant algorithm (e.g., RAID level 1, level 3, level 4, level 5, level 6, level 10, level 30, level 50, and/or level 60 algorithm). Then, in operation 806, a write command (one or more write commands) associated with data of the storage device may be automatically captured (e.g., by the write capture module 504) based on the fault-tolerant algorithm. Then, a differential rebuild may be applied on the storage device (e.g., using the differential rebuild module 514) when it is reengaged.

FIG. 9 is a three-dimensional view of an exemplary multi-depth storage enclosure 900 (e.g., hereafter enclosure 900) in which one or more storage devices may be removed in multiple ways, according to one embodiment. A set of rails 901 may be on either side of the enclosure 900 so that the enclosure 900 can easily slide outward from a rack of storage or networking equipment. The enclosure 900 can open from the top 904, and each capsule (e.g., a capsule 950) in a canister 906 can be individually removed. Each capsule (e.g., the capsule 950) includes a first storage device 902A and a second storage device 902B, as illustrated in FIG. 9. It should be noted that in alternate embodiments, each capsule 950 may include any number of storage devices.

Therefore, when an administrator removes the capsule 950, two storage devices are removed (902A and 902B). For example, if the storage device 902A is defective, an administrator could either remove the entire canister 906, and or individually remove the capsule 950 holding the defective storage device 902A. During the time the administrator is replacing a particular one or more defective storage device(s), either the entire canister 906 and/or the capsule 950 may be disengaged. When the administrator replaces the defective storage device (e.g., by installing a replacement storage device), certain ones of the storage device(s) that are functional and were not defective may be differentially rebuilt using the differential rebuild module 514 of FIG. 5 (e.g., so all of the data does not have to be reconstructed a differential approach can be used, that way only the data that was not written because the drive was disengaged is applied, rather than recopying all of the original data), while other ones of the storage devices(s) that are defective and now replaced may be fully rebuilt using the full rebuild module 512 of FIG. 5.

Although the present embodiments have been described with reference to specific example embodiments, it will be evident that various modifications and changes may be made to these embodiments without departing from the broader spirit and scope of the invention. For example, the various modules, detectors, rebuilders, etc. described herein may be performed and created using hardware circuitry (e.g., CMOS based logic circuitry), firmware, software and/or any combination of hardware, firmware, and/or software.

For example, the rebuild module 428 having the engage module 502, the write-capture module 504, the fault-tolerant application module 506, the reengage detector module 510, the full rebuild module 512, and/or the differential rebuild module 514 may be embodied using transistors, logic gates, and electrical circuits (e.g., application specific integrated ASIC circuitry) using a rebuild circuit having an engage circuit, a write-capture circuit, a fault-tolerant application circuit, a reengage detector circuit, a full rebuild circuit, and/or a differential rebuild circuit. In addition, it will be appreciated that the various operations, processes, and methods disclosed herein may be embodied in a machine-readable medium and/or a machine accessible medium compatible with a data processing system (e.g., a computer system). Accordingly, the specification and drawings are to be regarded in an illustrative rather than a restrictive sense.

What is claimed is:

1. A method, comprising:
applying a fault-tolerant algorithm to process commands associated with at least one storage device of a disk array that is disengaged; and
applying write data associated with the at least one storage device captured while the at least one storage device was disengaged to the at least one storage device when it is reengaged.

2. The method of claim 1, further comprising rebuilding the data state of the at least one storage device while it was disengaged on a replacement device.

3. The method of claim 2, wherein the applying write data captured while the at least one storage device was disengaged is performed on the replacement device.

4. The method of claim 3, wherein the replacement device is a spare device.

5. The method of claim 1, wherein the applying write data captured while the at least one storage device was disengaged is performed on the at least one storage device when it is reengaged.

6. The method of claim 1, wherein the fault-tolerant algorithm is at least one of a redundant array of independent disk (RAID) level 1, level 3, level 4, level 5, level 6, level 10, level 30, level 50, and/or level 60 algorithm.

7. The method of claim 1, wherein the write data is stored on a spare device of the disk array.

8. The method of claim 7, wherein the spare device is used to process commands associated with the at least one storage device of the disk array that is disengaged.

9. The method of claim 1, further comprising determining that the at least one storage device of the disk array is disengaged when a parameter exceeds a threshold value.

10. The method of claim 9, wherein the determining the at least one storage device of the disk array is disengaged further comprises reattempting a response request until a command parameter of the at least one storage device exceeds a particular value.

11. A method, comprising:
providing a canister having at least one unresponsive storage device and at least one functioning storage device that is disengaged; and
differentially rebuilding data on the at least one functioning storage device using a write command captured when the least one functioning storage device was disengaged.

12. The method of claim 11, further comprising processing commands associated with data of the canister based on a fault-tolerant algorithm while the canister is disengaged.

13. The method of claim 12, further comprising automatically capturing the write command associated with data stored in the canister based on the fault-tolerant algorithm.

14. The method of claim 13, wherein the fault-tolerant algorithm is at least one of a redundant array of independent disk (RAID) level 1, level 3, level 4, level 5, level 6, level 10, level 30, level 50, and/or level 60 algorithm.

15. The method of claim 11, further comprising detecting that storage devices within the disengaged canister have been reengaged and includes at least one replacement storage device.

16. The method of claim 15, further comprising fully rebuilding data of the at least one unresponsive storage device on the at least one replacement storage device using the fault-tolerant algorithm.

17. The method of claim 11, wherein the at least one unresponsive storage device is part of a storage volume comprising of multiple storage devices across different canisters.

18. The method of claim 11, further comprising rebuilding a data state associated with the at least one unresponsive storage device while the canister is disengaged on at least one replacement drive using a fault-tolerant algorithm.

19. The method of claim 18, wherein a write data is stored on a spare device of the disk array, and wherein the at least one replacement device is the spare device.

20. The method of claim 19, wherein the spare device is used to process commands associated with the at least one unresponsive storage device when the canister is disengaged.

21. The method of claim 11, further comprising determining that the at least one storage device in the canister is unavailable when a parameter exceeds a threshold value.

22. The method of claim 21, wherein the determining the at least one storage device in the canister is disengaged further comprises reattempting a response request until a command parameter of the at least one storage device exceeds a particular value.

23. A method, comprising:
determining that a storage device is disengaged;
processing commands associated with data on the storage device based on a fault-tolerant algorithm;
automatically capturing a write command associated with data of the storage device based on the fault-tolerant algorithm; and
applying a differential rebuild on the storage device when it is reengaged.

24. The method of claim 23, wherein the fault-tolerant algorithm is at least one of a redundant array of independent disk (RAID) level 1, level 3, level 4, level 5, level 6, level 10, level 30, level 50, and/or level 60 algorithm, and wherein the applying the differential rebuild further comprises applying write data captured when the storage device was disengaged to the storage device when it is reengaged.

25. A machine-readable medium embodying a set of instructions that, when executed by a machine, cause the machine to perform the method of claim 1.

26. A machine-readable medium embodying a set of instructions that, when executed by a machine, cause the machine to perform the method of claim 11.

27. A machine-readable medium embodying a set of instructions that, when executed by a machine, cause the machine to perform the method of claim 23.

28. A system, comprising:
means for applying a fault-tolerant algorithm to process commands associated with at least one storage device of a disk array that is disengaged; and
means for applying write data captured while the at least one storage device was disengaged to a data state before the storage device was disengaged.

29. An apparatus, comprising:
a processor connected to at least one memory through a bus; wherein the processor to:
determine that a storage device is disengaged;
process commands associated with data on the storage device based on a fault-tolerant algorithm;
automatically capture a write command associated with data of the storage device based on the fault-tolerant algorithm; and
apply a differential rebuild on the storage device when it is reengaged.
